(19) United States
(12) Patent Application Publication
(10) Pub. No.: US 2004/0003520 A1
(43) Pub. Date: Jan. 8, 2004

(54) Disposable easel

(76) Inventor: Jack Cameron Trew, Scottsdale, AZ (US)

Correspondence Address: Jack Trew, 14060 N. 58th Street, Scottsdale, AZ, 85254, US

(21) Appl. No.: 10/414,173

(22) Filed: Apr. 14, 2003

Related U.S. Application Data
(60) Provisional application No. 60/372,156, filed on Apr. 12, 2002.

(51) Int. Cl. G09F 1/00; A47G 1/16

(52) U.S. Cl. 40/124.01; 40/754

(57) ABSTRACT

This improved disposable easel looks similar to an artist's easel. The disposable easel supports displayed items generally of a size that would be placed on countertops, desktops, shelves, etc. Items displayed on the easel have a rearward incline of roughly 60 to 75-degrees. The disposable easel holds the item displayed through the use of slits cut in the easel “feet” and also a portion which protrudes outward pressing against the displayed item to help hold it firmly in place. The disposable easel is very simple to set up, affordable, and attractive for use in displaying photographs, greeting cards, love notes, business cards, electronic gift cards, and much more. Further, the disposable easel is adaptable for a variety of artistic, advertising, and promotional messages through printing and die cutting.

The present application claims priority under U.S. Provisional Application Serial No. 60/372,156, filed Apr. 12, 2002, entitled Disposable Easel.

### BACKGROUND OF THE INVENTION

This invention relates to a display method comprised of a designable easel for displaying generally flat items such as business cards, gift cards, greeting cards, posters, postcards, photos or the like. In the “folded state” the designable easel can be folded and easily stored in files, drawers, etc. In its assembled state, it forms a pyramidal structure which will suspend the flat panels for display in an upright position with a rearward inclination.

As stated, the present disposable easel was developed for suspending folded or unfolded display items, such as photographs, art, business cards, gift cards, greeting cards, posters, postcards, or the like, in an upstanding position.

In developing the easel, the following attributes were sought:

that it should be flat in the knocked down state, for shipping;

that it should suspend the display item above the support surface, so that the support surface will not be scratched by the displayed item;

that the easel should be adjustable, so that the angularity of the display item can be varied;

that the easel should have good footing and a good grip on the display item, so that the assembly is not easily overturned.

that the easel should be easily moveable by handling the item displayed.

that the easel should be safe for people by not having sharp edges.

that the easel should be light and have a low weight to weight supported ratio.

that the easel should be extremely compact so as to fit inside a wide variety of consumer carrying and storage devices.

that the easel should attractive and complimentary to the items being displayed.

that the easel should be affordable.

The following relevant prior art patents were noted in the prosecution of the parent of this application:

Wight in U.K. patent 113,330 teaches an easel which is flat in the knocked down state. The easel has triangular segments and is adapted to be bent along scored lines to form a pyramidal structure. As shown in FIGS. 3 and 4, the structure may have steps or projections extending forwardly at the base of its front edges, upon which the display card may rest.

Bird in U.S. Pat. No. 777,658 teaches a metal strip forming upwardly projecting hooks at each of its ends. The strip is bent into semi-circular form and a small display card may be inserted into the slots created by the hooks.

Considering the patents in chronological order, U.S. Pat. No. 871,833 relates to an easel attachment for a display card, wherein scored side panels of the easel can be folded outwardly and secured in coextensive relation by means of tab/slot fastener structures. The card to be supported is constituted as a piece separate from the easel, and the two are glued together, to form the composite display article.

U.S. Pat. No. 1,207,577 discloses an inclined support structure on a display box, wherein the support, prior to assembly, has a flattened configuration so as to reduce the overall size and bulk of the box, for storage and/or shipping. The support consists of multiple panels that can be unfolded into a semi-rigid, wedge-shaped base, upon which the box rests in order that the contents can be readily seen from one side thereof.

U.S. Pat. No. 1,767,753 relates to an easel construction adapted to be glued to an article to'be displayed, such as a picture or sign. The easel features adjustability as to the angle of support, by means of supplemental score lines “b”. These enable the easel panels to fold in the manner of a bellows, allowing expansion of the lower edge portions of the easel and thus varying the incline of the article being supported.

U.S. Pat. No. 1,890,258 relates to a display device for advertisements, comprising a sign portion and a pedestal portion. The two portions are secured by suitable adhesive. The combined sign and pedestal can be folded into a flat configuration as needed, for storage or shipping.

In U.S. Pat. No. 5,388,798, Glick discloses an easel generally diamond-shaped which folds to adopt a rearward incline “two-sided pyramidal form.” Items are placed in the easel and held with hooks which suspend, retain, and frictionally engage the “generally flat item received in the slots.” Glick did not address artistic issues including appearance similar to common dish easels, integrated graphics, artistic shapes. It also focused on the hook pressing against easeled items and the use of tension-based means and the bent pyramidal form, and so on.

U.S. Pat. No. 3,758,065 relates to an easel for supporting cards, posters, or tags. The easel per se, is constituted as cut-out or blank, formed from a sheet of cardboard or paper board.

British Patent No. 113,330, FIGS. 1 and 2, disclose an easel utilizing a stud fasteners. The resulting structure comprises essentially a triangular pyramid. FIGS. 14-16 show a combined easel support and picture frame, for supporting articles such as photos or display cards.

It appears that the devices noted above have not enjoyed commercial success to any significant extent. One possible explanation is the apparent disassociation between the support mechanisms that have been described and the specific articles that are intended to be displayed. Also, there does not appear to exist in the prior art, a truly simple, integrally formed support mechanism of a type which is affordably available at a retail, catalog, or other outlet for purchase by consumers for general use and/or mailing to a friend.

Also, consumers are not likely, when acquiring photos, cards, art, etc., to be overly concerned with its ultimate disposition. Instead, the purchaser's main interest is in possessing an item for display and often needing a simple solution for displaying the item.

### SUMMARY OF THE INVENTION

Accordingly there has existed a long-felt need for a disposable easel, such that the user, upon assembling the disposable easel, automatically has in hand, a supporting structure that he can utilize to display a photograph, greeting card, art, business cards, place cards, note cards, etc. on a counter, desktop, shelf, or other surface, as desired, and with a minimum of time and effort expended in figuring out what to do with the disposable easel and item displayed assembled or examined. Items many times the size and weight of the disposable easel can be supported.

Accordingly, the present invention obviates the problem of conveniently and inexpensively displaying a photograph, greeting card, art, business cards, place cards, note cards, etc., for subsequent viewing. Thus an object of the invention is to provide a novel and improved integrally-designed, low-cost disposable easel which is extremely simple in its structure, and economical to manufacture and assemble.

A related object of the invention is to provide an improved multi-purpose, disposable easel as above set forth, which is light-weight so as to not introduce significant extra expense, as for example, should it be mailed and possibly incur added postage due to either overweight, or oversize physical characteristics.

Still another object of the invention is to provide an improved method for people to express love, pride, friendship, thank you, etc., using an a novel and improved integrally-designed, low-cost disposable easel of the kind indicated, which can be readily mass produced and sold at a minimum overall cost.

Still another object of the invention is to provide a novel and improved integrally-designed, low-cost disposable easel, which is especially eye-catching, patriotic, and love-evoking, thereby having overall appeal to the consumer and rendering the article highly saleable as a marketable item.

In accomplishing the above objects the invention provides as a new article of manufacture, a combination a novel and improved integrally-designed, low-cost disposable easel. Displayed items are mounted onto the disposable easel, which is foldable to roughly a 90 degree angle, having interlocking arms which ensure the folded angle remains relatively unchanged through use, and which also create tension holding the displayed items in place when placed by the user to the easel.

The arrangement is such that the consumer can purchase the disposable easel in a folded condition in a package, which largely resembles at a minimum, the size and configuration of a folded business card.

The gripping nature of the disposable easel design allows the recipient to easily move the display system in a variety of places for many subsequent viewings at home, work, or other local. Another advantage of the easel is its use in the display of other items including postcards, greeting cards, advertisements, business cards, children's artwork, and many other decorative, personal, and commercial messages.

As an added advantage, the construction can be virtually 100% cardboard and is free of glue or other difficult-to-learn assembly requirements.

It is the primary object of the present invention to provide a simple yet effective easel. This and other objects of the invention will become clear from an inspection of the detailed description of the invention, and from the appended claims.

### BRIEF DESCRIPTION OF THE DRAWINGS

The drawings illustrate a preferred embodiment of the invention:

FIG. 1 is a plan view of a die-cut blank of cardboard as utilized in the fabrication of the disposable easel. The blank comprises an easel portion, a head portion, a gripping feet portion, interlocking arm portion, and a pitch portion. The displayed item at the lower end are the legs, which rest upon a surface and support the display system. The feet serve to grip the displayed items. The interlocking arms provide stability and gripping tension.

FIG. 2 is a front elevation view of an easel of FIG. 1 having been folded down a centerline of weakness, and arms interlocked creating a mostly 90 degree angle of the side panels.

FIG. 3 is a plan view of the easel having been folded down a centerline of weakness.

FIG. 4 is a plan view of the easel having been folded down a centerline of weakness, and arms interlocked.

FIG. 5 is a top plan view of the assembled easel creating a mostly 90-degree angle of the side panels.

FIG. 6 is a right side elevation view of an easel of FIG. 4 having been folded down a centerline of weakness, and arms interlocked creating a mostly 90 degree angle of the side panels.

FIG. 7 is a right side elevation view of an easel of FIG. 4 having been folded down a centerline of weakness, arms interlocked, and the side panel angle becoming extended obtusely thereby creating protruding interlocking arms that create gripping of displayed items.

FIG. 8 is a rear edge elevation view of an easel of FIG. 4 having been folded down a centerline of weakness, and arms interlocked.

FIG. 9 is a front elevation view of a disposable easel with a folded business card, place card, business card, gift card, electronic gift card, phone card, or other card inserted in the gripping feet and held with tension by the interlocking arms of FIG. 4.

FIG. 10 is a side edge elevation view of a disposable easel with a folded business card, place card, business card, gift card, electronic gift card, phone card, or other card inserted in the gripping feet and held with tension by the interlocking arms of FIG. 4.

FIG. 11 is a front edge elevation view of a disposable easel with a photograph, greeting card, kid's art, thank you, or other item inserted in the gripping feet, held with tension by the interlocking arms, and adjusted in rearward inclination by the easel head portion of FIG. 4.

FIG. 12 is a side edge elevation view of a disposable easel with a photograph, greeting card, kid's art, thank you, or other item inserted in the gripping feet, held with tension by the interlocking arms, and adjusted in rearward inclination by the easel head portion of FIG. 4.

FIG. 13 is a side edge elevation of a disposable easel with a photograph, greeting card, kid's art, thank you, or other item inserted in the gripping feet, held with tension by the interlocking arms, and adjusted in rearward inclination by the easel head portion of FIG. 4 showing a change in rearward angle of inclination of the displayed item and interlocking arms (crossbar/strut) tension causing a bow in the displayed item and enhanced grip by the easel feet of FIG. 4.

FIG. 14 is a bottom edge elevation view of a disposable easel of FIG. 7.

FIG. 15 is a bottom “plan” view of a disposable easel of FIG. 7.

FIG. 16 is a top edge elevation view of a disposable easel of FIG. 7.

FIG. 17 is a top “plan” view of a disposable easel of FIG. 7.

FIG. 18 is an alternative embodiment of a disposable easel.

FIG. 19 is another alternative embodiment of a disposable easel.

FIG. 20 is yet another alternative embodiment of a disposable easel.

### DETAILED DESCRIPTION OF THE DRAWINGS

Essentially the present invention embraces, as a new article of manufacture, a multi-purpose disposable easel as a practical, decorative or ornamental article of display on a table, desk, or other surface.

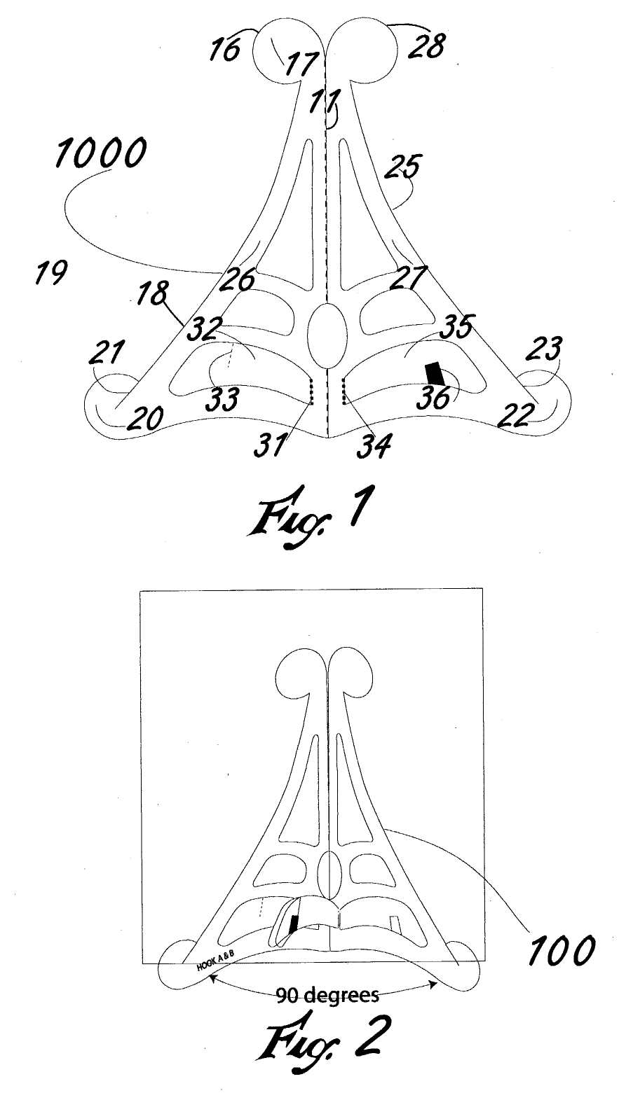

In accomplishing the multi-purpose function, namely a disposable easel and artistic piece, and display article, there is provided a die-cut blank of cardboard generally designated by the numeral 1000, FIG. 1, which is so arranged to comprise five individual sections or portions, namely an easel portion, a head portion, a gripping feet portion, interlocking arm portion, and a pitch portion, the nature of these being described in more detail hereinbelow.

FIG. 1 shows the initial form of the easel die-cut blank 1000. As can be readily understood, a large number of such forms can be laid out on an expansive flexible material, and a series of blanks formed simultaneously therefrom by blanking techniques that are, per se, known in the art.

FIG. 1 is a plan view of a die-cut blank of cardboard or other material as utilized in the fabrication of the disposable easel. The blank comprises an easel portion, a head portion, a gripping feet portion, interlocking arm portion, and a pitch portion. The easel portion height and panel width define the basic rearward angle of inclination of the displayed item. The head portion creates adjustable angles of inclination. The easel portion between the two panels and up to a half inch on each side of the centered vertical fold line supports the pressure exerted by items mounted on the disposable easel. The gripping feet portion serve to grip the displayed item, which rest upon a surface and support the displayed item. The interlocking arm portion provides stability and gripping tension. The pitch portion serves to alter the rearward angle of inclination of the item being displayed.

In order to provide an artistic (glossy, high-contrast color illustration, picture, embossment, sculptured die-cut, etc.) on the surfaces of the disposable easel, the sheet (not shown) from which the blanks are cut is first printed, hot foil stamped, sculpted, embossed, etc. with the desired artistic material In FIG. 1, the artistic impression is impressed on one or both sides of the reverse of the rectangular panel from which the easel emerges, for example.

By the invention, there is created a unique configuration involving the various portions of the blank 1000, in order to provide the desired end-product when the blank 1000 is folded, and subsequently unfolded, interlocked, and displayed by the recipient, in accordance with the teachings of the present invention.

Referring now again to FIG. 1, a fold line 11 is preferably impressed or stamped at the time of the die-cutting which ultimately define the configuration of the folded easel panels to be described below. The easel comprises 2 halves, a left-side panel 26 and right-side panel 27. The fold line produces a centerline of weakness to permit easy opening and adjusting by the recipient.

Also, by the invention, the easel is provided with artistic perimeter die-cuts 25 which ultimately define the configuration of easel panels to be described below. In addition, the perimeter die-cuts at 18 generally help develop an angle of inclination for items roughly half the height of the fully assembled disposable easel and held by the easel such as the displayed item of FIG. 1. The perimeter cuts at the top of the easel at 16 and 28 create another structure called the “head” which has the purpose of permitting the recipient to move the position of these to make changes in the angle of inclination of items held by the easel.

Also, by the invention, the easel is folded by the recipient at 11 to approximately a 90 degree angle. This folding by the recipient fully enables the easel to stand upright with the left side panel at 26 and right side panel at 27 resting upon a horizontal surface. Once in the standing position, it further enables the recipient to use the easel to display a greeting card, panel, photograph, or other item.

Referring now again to FIG. 1, die cuts are created stamped at the time of the die-cutting which define the configuration of interlocking arms at 32 and 35, the purpose of which is to create a mechanism providing stability for the easel and to assist recipients from having the easel open beyond a 90 degree angle.

Referring now again to FIG. 1, interlocking arm notches are created at the time of the die-cutting at 33 and 36 which define notches which serve the purpose of permitting the recipient to interlock the “arms,” thereby (1) stabilizing the easel, (2) assuring a range of rearward angle of inclinations of displayed items, (3) providing tension which assists the “feet” in gripping the displayed item, and (4) assisting in developing a rearward angle of inclination for items displayed which are under 60% of the total height of the easel.

Further by the invention, the gripping feet portion 20 and 22 have a die cut extending diagonally from the top of the easel down into the center of the rounded gripping feet, which comprise substantially a circle in appearance, but may take other shapes. These cuts extend upward at roughly a 48-degree angle at 21 and 23. These cuts permit the recipient to insert a flat card, panel, photograph, printed product, or other item, whereby the item is gripped by the “feet.”

In assembly of the easel to form the fully functional disposable easel, both panels formed by fold line 11, FIG. 1, are folded to form roughly a 90-degree angle in the manner of the front elevation view of FIG. 2 and as viewed by a user as it rests on a horizontal surface such as a table top, counter, etc.

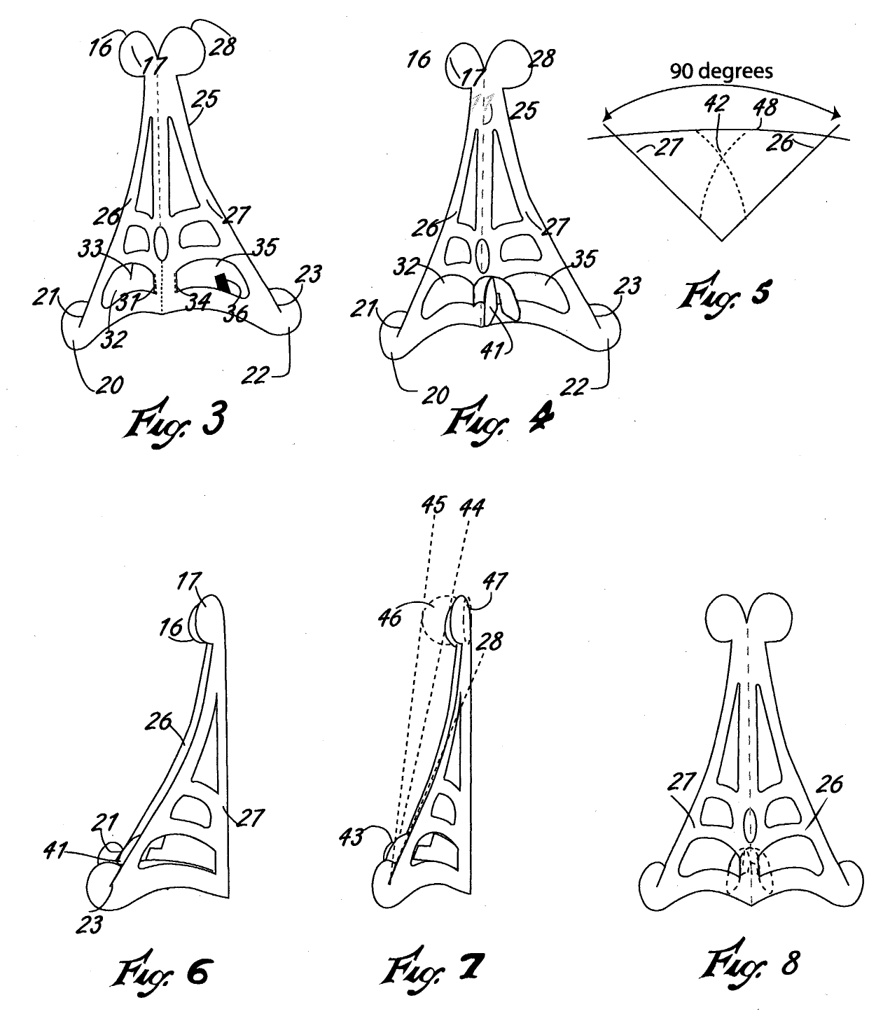

FIG. 3 continues the assembly of the easel by showing the interlocking arms as they would appear to a user after having folded the left panel at 26 and right panel at 27 to a 90-degree angle.

Users would fold the arms of FIG. 3, along the fold lines at 31 and 34. After folding, the two arms form an angle of approximately 62 degrees toward the inside of the two panels, at 26 and 27.

The user would grasp interlocking easel arm of 32 and 35. The two notches die cut into the interlocking arms at 33 and 36 are interlocked so that the bottom of the die cut at 33 is will touch the top of the rectangular piece cut out of 35 at the top of the removed portion 36.

After interlocking, the assembled disposable easel assumes a rearward angle of inclination of approximately 60 degrees toward the inside of the two panels of FIG. 1 of 26 and 27.

FIG. 4 is a front elevation view of the assembled disposable easel as a user would view prior to displaying an item.

FIG. 5 is a bottom plan view of the interlocking arms as they are folded toward the inside of the two panels at 41, and interlocked (nested in a locking slot). Also noticeable is the 90-degree angle formed by users folding the left side panel at 26 and right side panel at 27.

A significant improvement is achieved through the tension created through the bowing of the interlocking arms. The interlocked arms create an intersecting center point so that cards mounted into easel can receive tension pushing outward from the at a point which bisects the angle created between the vertical folded panels of FIG. 4 at 27 and 27. In turn, this tension is transferred to the displayed item (business card, greeting card, gift card, photograph, printed product, illustration, etc.) thereby keeping the easel firmly gripped to the displayed item.

FIG. 6 is a side elevation of the assembled easel of FIG. 4. The two vertical side panels of the easel 26 and 27 form mostly a 90-degree angle (as shown in FIG. 4) when folded along the vertical score line at 11. The interlocking arms protrude from this vertices where the two panels join along the vertical fold line. The interlocked arms push outward against items mounted across the two gripping feet of 21 and 23, pushing outward at 41.

Additional protruding of the interlocking arms at 41 is possible for the user to create by opening the two side panels beyond a 90 degree angle. This creates a protruding which pushes against a displayed item serving to opening further than 90 degrees into an obtuse angle. This significant improvement keeps the disposable easel in balance by pushing against the displayed item, yet, tension exists to stop the disposable easel from opening beyond the 90-degree angle. This also enables the disposable easel to handle displayed items many times taller and wider than the assembled disposable easel.

FIG. 7 is a right side elevation of the assembled easel of FIG. 4. It shows the change in the rearward angle of inclination of the displayed items when users move the position of the head portion of 16 and 28 of FIG. 4. The folded easel forms an angle at the head which is also roughly a 90-degrees. The adjustment of the head portion in as shown in FIG. 7 at 46 and 47 discloses the change in the displayed item's rearward angle of inclination at 28, 45, and 44. The change at 28, 45, and 44, ranges from 67 degrees, up to 82 degrees for the displayed item.

The significant improvement of this new article of manufacture includes self-gripping and adjustability, stability, capacity. When the disposable easel panels are spread beyond 90 degrees, the more the tension presses against the displayed item, thereby gripping the item more firmly. In addition, the user can increase the displayed item's rearward inclination through adjustment of the head portion, thereby adjusting the reward angle of inclination up to 82 degrees.

Another significant improvement is the use of paper and other limited flexibility products in the making of a freestanding disposable easel. This use permits the addition of 4-color processes, hot foil stamping, embossing, die cutting, and many other modifications.

FIG. 8 is a rear elevation of the assembled easel of FIG. 4.

In this or other designs, the easel has an attractive, finished appearance, and uses for items not part of the original display system.

The recipient thus has the added enjoyment of subsequent viewing of the displayed objects, as opposed to the usual disposition of conventional displays, which are often viewed only upon receipt. This display system enables subsequent enjoyment and the ability to easily move the display system, or disassemble and relocate the system in an office or other setting.

The one-piece die-cut cardboard or other construction from materials of limited flexibility provides the easel an extremely simple manufacturing process. Also, the easel is completely self-supporting, and no additional glues or adhesives of any type are involved in assembling the combined post card and easel.

A distinct advantage of the product of the invention is the integrity of the easel and display; at the time of purchase of the display system, the mechanism for supporting known, and may accompany the other components and is included for use by the recipient, until after his initial inspection of the displayed item is completed, and these are to be either stored or disposed of

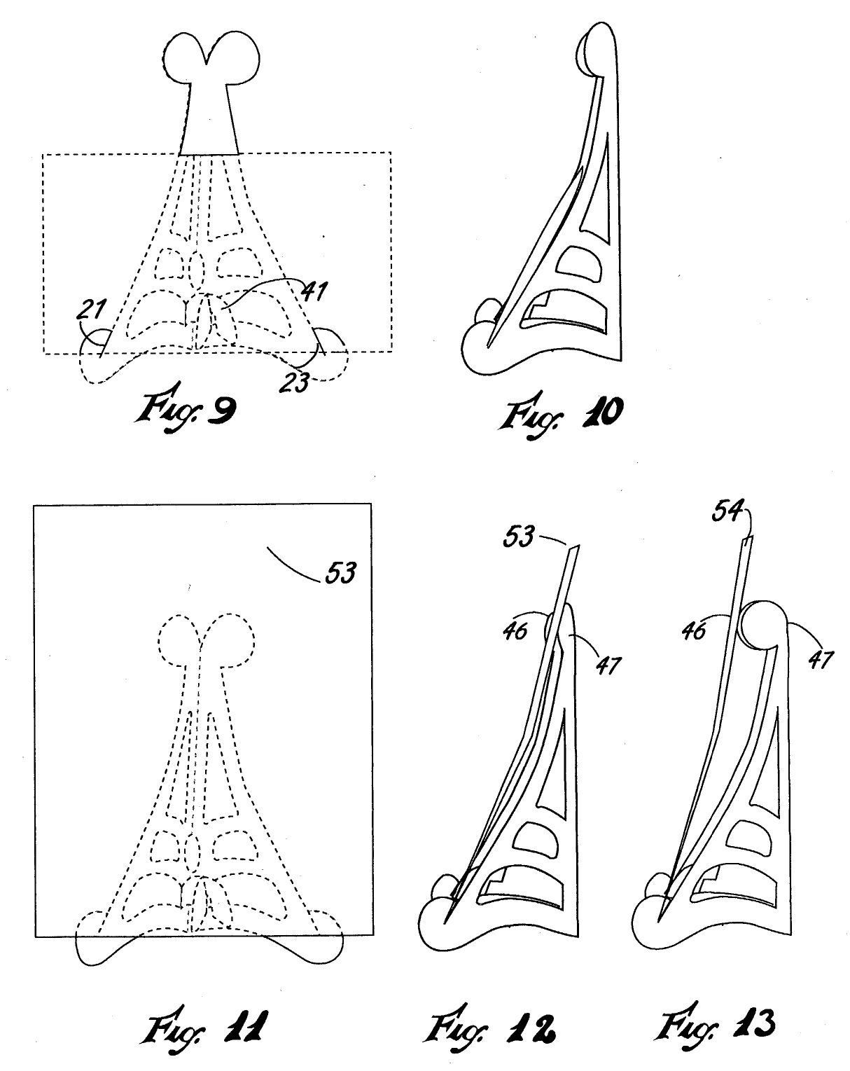

FIG. 9 is a front elevation view of a disposable easel with displayed item being potentially a folded business card, place card, business card, gift card, electronic gift card, phone card, or other item that is roughly two-thirds the height of the disposable easel. The displayed item is inserted in the gripping feet and held with tension by the interlocking arms of FIG. 4. The disposable easel provides a low center of gravity. The gripping feet at 21 and 23 are unobtrusive, elegant, and safe for use in many environments. Rounded corners of the gripping feet present satisfying curved lines that are largely out of the view of the displayed object. Likewise, the rounded edges are deliberately designed to ensure sharp corners do not pose a safety hazard to young children. The interlocking arms of FIG. 4 at 41 show a low position on the displayed item creating tension, increasing stability, and establishing a rearward angle of inclination of the displayed object.

FIG. 10 is a side edge elevation view of a disposable easel with displayed item being potentially a folded business card, place card, business card, gift card, electronic gift card, phone card, or other item that is roughly two-thirds the height of the disposable easel. The displayed item is inserted in the gripping feet and held with tension by the interlocking arms of FIG. 4.

FIG. 11 is a front edge elevation view of a disposable easel of FIG. 4, with displayed item being potentially a photograph, greeting card, kid's art, thank you, or other item or other item which is up to 6 times the height and/or width of the disposable easel at 53. The displayed item is inserted in the gripping feet and held with tension by the interlocking arms.

FIG. 12 is a side edge elevation of the disposable easel and displayed item mounted and gripped on an easel. The easel is in the normal position with the left and right panels opened to roughly 90 degrees. The head portion is opened at roughly a 160-degree angle at 46 and 47 by the user, thereby creating a 70 degree angle of inclination for the displayed item. A distinct advantage of the of the invention is it's ability to provide create a rearward inclination that is suitable for most uses of a broad range of displayed items. The displayed item is inserted in the gripping feet and held with tension by the interlocking arms.

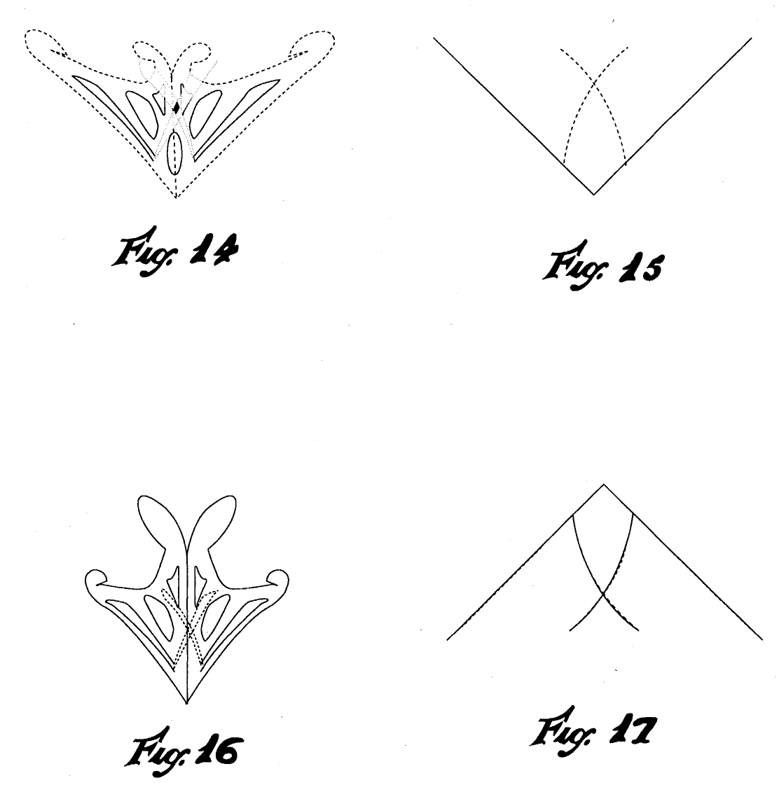

FIG. 13 is a side edge elevation of the disposable easel of FIG. 4, and displayed item mounted and gripped on an easel. The easel is in the normal position with the left and right panels opened to roughly 90 degrees. The head portion is opened at roughly a 25 degree angle at 46 and 47 by the user, thereby creating a 75 degree angle of inclination for the displayed item. A distinct advantage of the of the invention is it's ability to increase the rearward inclination toward a true vertical position so that the disposable easel can handle a larger, and heavier load. The displayed item is inserted in the gripping feet and held with tension by the interlocking arms.

FIG. 14 is a bottom edge elevation view of a disposable easel of FIG. 4.

FIG. 15 is a bottom “plan” view of a disposable easel of FIG. 4.

FIG. 16 is a top edge elevation view of a disposable easel of FIG. 4.

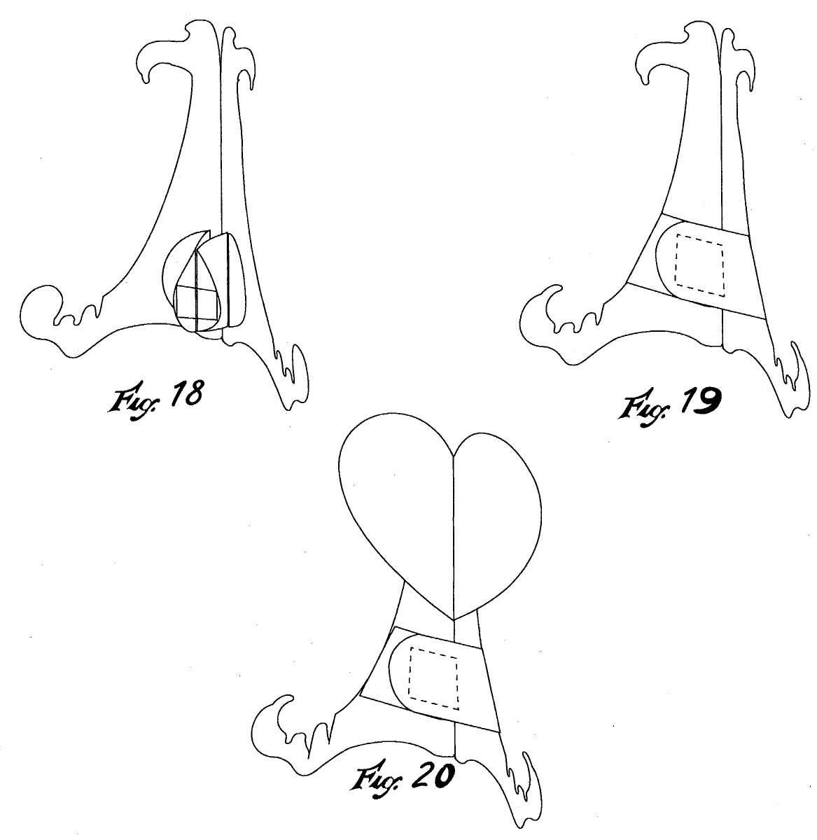

FIG. 17 is a top “plan” view of a disposable easel of FIG. 4.

An alternative embodiment of can be seen in FIG. 18. The in this version of the preferred embodiment, two additional sets of gripping feet are placed in the easel legs. The interlocking arms adhesively connect after being “popped out” from the die cut and nicked easel substrate. Peel and stick tape might be applied, during mass production, permanent adhesive might be applied and the easel folded, and other means commonly used by those skilled in the art of die cutting, mass production, and so on. Further, the easel substrate has additional artistic embellishments to conform to the kinds of shapes commonly found in dish and house easels. Similar to the alternative embodiment of FIG. 18, the easel also has other adaptations including multicolor artwork, coatings, laminates, synthetic substrates, embossments, die cuts, and other embodiments known by those skilled in the art. The center score line also is slit and/or scored on the exterior side with the opposite (interior) side of the centerline having substrate surface coatings to act as a hinge.

A second alternative embodiment of can be seen in FIG. 19. The interlocking arms have been modified to take any of a variety of shapes which adhesively connect. These interlocking arms act as overlapping flaps which attach to each other through permanent, repositionable, peel and stick or other adhesive to lock and thereby restrict the opening of the easel panels to approximately a 90 degree angle. The arms might also attach to the item being easeled or be an artistic display element. Further, the easel substrate has additional artistic embellishments to conform to the kinds of shapes commonly found in dish and house easels. Similar to the alternative embodiment of FIG. 18, the easel also has other adaptations including multicolor artwork, coatings, laminates, synthetic substrates, embossments, die cuts, and other embodiments known by those skilled in the art. The center score line also is slit and/or scored on the exterior side with the opposite (interior) side of the centerline having substrate surface coatings to act as a hinge.

Another alternative embodiment of can be seen in FIG. 20. The interlocking arms have been modified to adhesively attach to the easeled item. These interlocking arms attach through permanent, repositionable, peel and stick or other adhesive to lock and thereby restrict the opening of the easel panels to approximately a 90 degree angle. Further, the easel substrate has additional artistic embellishments to conform to the kinds of shapes commonly found in dish and house easels. Similar to the alternative embodiment of FIG. 18, the easel also has other adaptations including multicolor artwork, coatings, laminates, synthetic substrates, embossments, die cuts, and other embodiments known by those skilled in the art. The center score line also is slit and/or scored on the exterior side with the opposite (interior) side of the centerline having having substrate surface coatings to act as a hinge. This adaptation is especially useful in commercial applications wherein the item easeled requires that it be attached to the easel and that logos, social themes, and other shapes further serve to express the integrated artwork.

From the above it can be seen that I have provided a novel and improved disposable easel, which are simple in structure and convenient to use. Recipients are conveniently supplied with all that is required to create an unusual, attractive item of display or decoration, or as part of a collection of professional and/or personal mementos.

The disclosed invention is thus seen to represent a distinct advance and improvement in the field of display articles of the type that are sold at retail and adapted for postal or courier-type delivery.

It will thus be seen that according to the present invention a desirable easel for displaying a wide variety of items. While the invention has been herein shown and described in what is presently conceived to be the most practical and preferred embodiment thereof, it will be apparent to those of ordinary skill in the art that any modifications may be made thereof within the scope of the invention, which scope is to be accorded the broadest interpretation.

The embodiments of the invention in which an exclusive property or privilege is claimed are defined as follows:

1. As a new article of manufacture, a folded easel combining display element and an artistic expression element comprising in combination:
a) a die-cut blank having an easel portion, a head portion, a gripping feet portion, interlocking arm portion, and a pitch portion.
b) said easel portion having three fold lines to enable panels on each half of the easel to be folded independently of the display and address and message portions, and fold lines at the base of the interlocking arm portion,
c) said head portion being an element of said easel portion,
d) said gripping feet portion being an element of said easel portion, and
e) said interlocking arm portion being an element of said easel portion.
f) said pitch portion being an element of said easel portion.

2. The new article of manufacture as set forth in claim 1, wherein:
The easel is very simlar in shape to the common dish easel, that it, it is substantially “T”-shaped (upside down) in combination with a plurality of triangular, circular, square, and polygonal shapes creating a visually appealing artistic appearance. The easel body is formed from an upside down “T” shape, to a fully rectangular shape that has a line of weakness in the center that allows the shaped to be folded. The easel body stands vertically as two substantially right triangular side panels. The centerline of weakness, when folded, forms the backbone of the easel. The front lower edges of the easel body have supports, referred to as legs. The legs form a base that holds the bottom of displayed items through the use of “gripping feet”. Immediately above the legs are arms, which are provided a line of weakness and notches to enable both to be interlocked. When opened and interlocked, the easel is substantially at a 90 degree angle. The sides may adopt a generally pyramidal configuration with load-supporting edges being a rearward inclination, the front and bottom of the pyramidal easel member being open. At the upper end of the easel is the “head” for absorbing loads and permitting adjustment of the angle of inclination from 55 degrees to 75 degrees.

3. The new article of manufacture, i.e., disposable easel as set forth in claim 1 wherein the easel is comprised of a plurality of head shapes permitting the user to have material with which to pick up the display system.

4. The new article of manufacture, i.e., disposable easel as set forth in claim 1 wherein the easel is comprised of outer edges in the lower half of the display system which may be used to define the a specific rearward angle of inclination.

5. The new article of manufacture, i.e., disposable easel as set forth in claim 1 wherein the easel legs have feet which are scored creating grips based upon deflection and tension upon insertion of a displayed item.

6. The new article of manufacture, i.e., disposable easel as set forth in claim 1 wherein the easel is comprised of interlocking arms which interlock keeping the easel from substantially opening beyond a 90 degree angle.

7. The new article of manufacture, i.e., disposable easel as set forth in claim 1 wherein the easel is comprised of interlocking arms which interlock and protrude outward as users open the set up the easel, thereby pressing perpendicularly against the displayed item creating additional tension where the feet grip the displayed item.

8. The new article of manufacture, i.e., disposable easel as set forth in claim 1 wherein the easel is comprised of a plurality sizes permitting the easel to range in from roughly 4 inches by 4 inches to substantially larger sizes accommodating a variety of commercial and private uses.

9. The new article of manufacture, i.e., disposable easel as set forth in claim 1 wherein the easel is comprised of a plurality of shapes to express a wide variety of artistic expressions through printing, embossing, hot foil stamping, scoring, and die cutting.

11. The new article of manufacture, i.e., disposable easel as set forth in claim 1 wherein the easel is adjustable to ensure the display system strongly grips the displayed items and adapts to the demands of the load created by the displayed item.

12. The new article of manufacture, i.e., disposable easel as set forth in claim 1 wherein the easel comprises a plurality of material thicknesses, derived from a plurality of coatings, laminates, and other structural and artistic materials known by those skilled in the art, for adjusting the load bearing capacity of the display system.

13. The new article of manufacture as set forth in claim 1, wherein said item creates tension from interlocking arms securing displayed items in a manner which is designed to create a low center of gravity.

14. The new article of manufacture as set forth in claim 1, wherein said item has compact construction to ensure the maximum amount of carrying capacity relative to its size and materials used.

15. The new article of manufacture as set forth in claim 1, wherein said item has stability through its interlocking arms which prevent movement of the left and right side easel panels substantially beyond 90 degrees, thereby ensuring easel stability.

16. A method of manufacturing a flat easel consisting of a combined disposable easel, stabilizing features, and adjustability, comprising the steps of:
a) forming a blank of cardboard, by die-cutting,
b) imparting one fold line in said elongate blank, so as to divide the blank into two panels,
c) imparting two fold lines in said blank, so as create a foldable interlocking arms portion,
d) die cutting notches in the foldable interlocking arms portion to enable the arms to attach securely to each other, thereby stabilizing the entire easel,
e) die cutting slits in the feet portion to enable items to be inserted for display purposes, and
f) die cutting a head portion to permit the changes in the rearward inclination of the displayed item.

17. The new article of manufacture as set forth in claim 1, wherein said item has a lower “pitch portion” creating a rearward angle of inclination for items roughly half the size of the height of the disposable easel.

18. The new article of manufacture as set forth in claim 1, wherein said item has rounded edges are deliberately designed to ensure sharp corners do not pose a safety hazard to young children.

19. The new article of manufacture as set forth in claim 1, wherein said item has interlocking arms placed in a low position on the displayed item creating tension, increasing stability, and establishing a rearward angle of inclination of the displayed object.
